(19) United States
(12) Patent Application Publication
(10) Pub. No.: US 2017/0061378 A1
(43) Pub. Date: Mar. 2, 2017

(54) SHARING SIMULATED DATA STORAGE SYSTEM MANAGEMENT PLANS

(71) Applicant: International Business Machines Corporation, Armonk, NY (US)

(72) Inventors: Rotem Klein, Kiryat Ono (IL); Nadav Parag, Rehovot (IL); Tamir Riechberg, Hod HaSharon (IL); Avraham S. Sabzerou, Ganey Tikva (IL); Vladimir Shalikashvili, Petah Tiqwa (IL); Moshe Weiss, Peta Tiqwa (IL); Moshe Zemah, Rishon LeZion (IL)

(21) Appl. No.: 14/842,059

(22) Filed: Sep. 1, 2015

(51) Int. Cl. G06Q 10/10; G06Q 10/06

(52) U.S. Cl. CPC G06Q 10/103; G06Q 10/067

(57) ABSTRACT

An approach for sharing simulated data storage system management plans is provided. One or more effects of a resource management plan are simulated on a data storage system by generating a simulation based, at least in part, on the data storage system and the resource management plan. Access to the simulation is granted to at least one person who is not an author of the resource management plan. Feedback of one or more types is received from the at least one person. The data storage system is modified based, at least in part, on the resource management plan and the feedback of one or more types from the at least one person.

### BACKGROUND OF THE INVENTION

The present invention relates generally to the field of computer data storage, and more particularly to sharing simulated data storage system management plans.

System administrators are responsible for the upkeep, configuration, and reliable operation of computer systems. In general, system administrators seeks to ensure that the uptime, performance, resources, and security of the computers that they manage meet the needs of users. There are many types of system administrators. One type of system administrator is a storage administrator. Storage administrators typically create, provision, and add or remove storage resources to and from data storage systems.

Multi-array storage systems typically comprise multiple granularities. For example, a storage system can include multiple sites, and each of the sites can include multiple storage arrays that include multiple storage controllers. Each of the storage controllers can manage multiple storage pools that are used to implement thick and/or thin management for logical volumes. Utilization of the storage system can be measured at different granularities such as the storage system as a whole, one or more specific site in the storage system, one or more arrays at a specific site, a specific pool, and a specific volume in a specific pool. System administrators who manage multi-array storage facilities create resource management plans to manage data at various levels of granularity.

### SUMMARY

According to one embodiment of the present disclosure, a method is provided. The method includes simulating, by one or more computer processors, one or more effects of a resource management plan on a data storage system by generating a simulation based, at least in part, on the data storage system and the resource management plan; granting, by one or more computer processors, access to the simulation to at least one person who is not an author of the resource management plan; receiving, by one or more computer processors, feedback of one or more types from the at least one person; and modifying, by one or more computer processors, the data storage system based, at least in part, on the resource management plan and the feedback of one or more types from the at least one person.

According to another embodiment of the present disclosure, a computer program product is provided. The computer program product comprises a computer readable storage medium and program instructions stored on the computer readable storage medium. The program instructions include program instructions to simulate one or more effects of a resource management plan on a data storage system by generating a simulation based, at least in part, on the data storage system and the resource management plan; program instructions to grant access to the simulation to at least one person who is not an author of the resource management plan; program instructions to receive feedback of one or more types from the at least one person; and program instructions to modify the data storage system based, at least in part, on the resource management plan and the feedback of one or more types from the at least one person.

According to another embodiment of the present disclosure, a computer system is provided. The computer system includes one or more computer processors, one or more computer readable storage media, and program instructions stored on the computer readable storage media for execution by at least one of the one or more processors. The program instructions include program instructions to simulate one or more effects of a resource management plan on a data storage system by generating a simulation based, at least in part, on the data storage system and the resource management plan; program instructions to grant access to the simulation to at least one person who is not an author of the resource management plan; program instructions to receive feedback of one or more types from the at least one person; and program instructions to modify the data storage system based, at least in part, on the resource management plan and the feedback of one or more types from the at least one person.

### BRIEF DESCRIPTION OF THE DRAWINGS

FIG. 1 is a block diagram depicting a data processing storage subsystem, in accordance with an embodiment of the invention.

FIG. 2 is a block diagram depicting a network that includes multiple storage controllers and multiple system administrator consoles, in accordance with an embodiment of the present invention.

FIG. 3 is a flowchart depicting operations for simulating the effects of resource management plans on a computing device within the computing environment of FIG. 2, in accordance with an embodiment of the present disclosure.

FIG. 4 is a block diagram depicting a graphical user interface for sharing a simulated resource management plan, in accordance with an embodiment of the present disclosure.

FIG. 5 is a block diagram depicting a graphical user interface for selecting a simulated resource management plan, in accordance with an embodiment of the present disclosure.

FIG. 6 is a block diagram depicting a graphical user interface for reviewing a simulated resource management plan, in accordance with an embodiment of the present disclosure.

### DETAILED DESCRIPTION

Embodiments of the present disclosure recognize a need to simulate changes in a data storage system to allow system administrators to analyze and/or discuss the effects of the proposed changes. System administrators increasingly manage complex data storage systems that include multiple sites, each site including multiple arrays, each array including one or more storage pools, and each storage pool including one or more logical volumes distributed over multiple computer storage devices. It is often advantageous to have multiple system administrators with different responsibilities manage complex storage systems. Any one system administrator, however, may not fully understand how his or her proposed changes will affect the resources that are available to other system administrators. It is advantageous to simulate changes before they take affect so that other system administrators can verify that the changes will not negatively affect the portions of the system that they manage and provide comments and/or make modifications to the proposed changes if, for example, conflicting resource requirements are discovered. Embodiments of the present disclosure provide the capability to simulate changes to a data storage system before the changes take effect. Embodiments of the present disclosure also enable interested persons to provide feedback regarding the proposed changes. Feedback of various types can be provided, including approval indicators, disapproval indicators, comments, and proposed modifications. Embodiments of the present disclosure can thereby enable system administrators to become more collaborative by sharing plans and ideas.

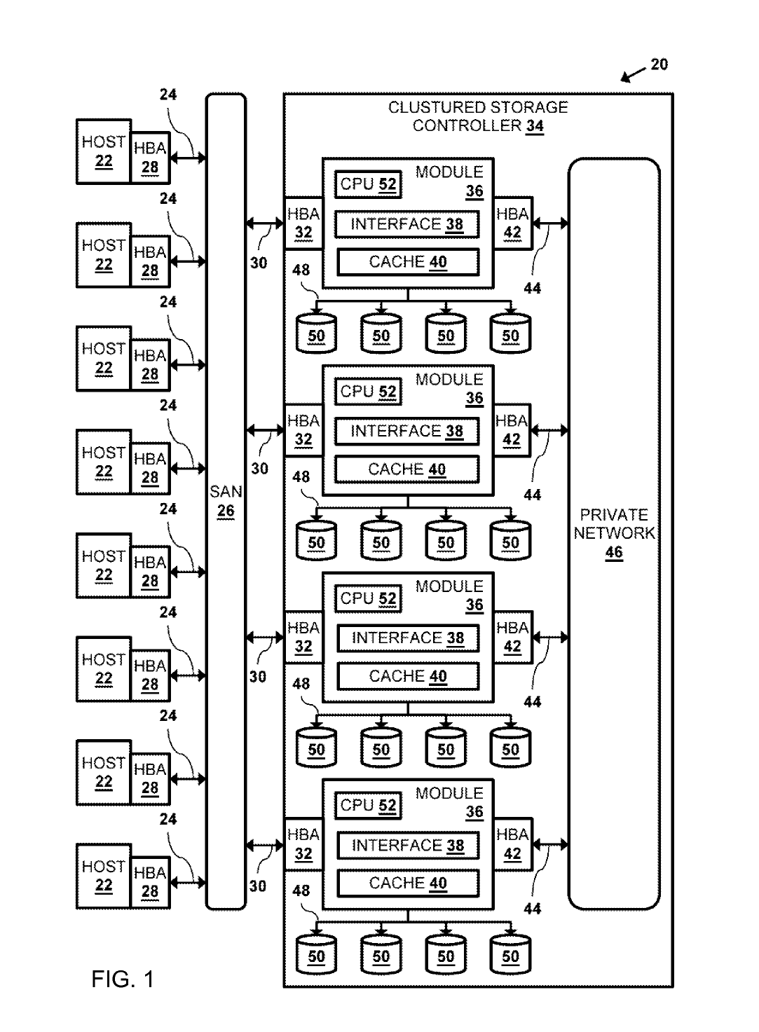

The present disclosure will now be described in detail with reference to the Figures. FIG. 1 is a block diagram depicting a data processing storage subsystem, in accordance with an embodiment of the invention. The particular subsystem shown in FIG. 1 is presented to facilitate an explanation of the invention. However, as the skilled artisan will appreciate, the invention can be practiced using other computing environments, such as storage system that include other storage subsystems with diverse architectures and capabilities.

Storage subsystem 20 receives, from one or more host computers 22, input/output (I/O) requests, which are commands to read or write data at logical addresses on logical volumes. Any number of host computers 22 are coupled to storage subsystem 20 by any means known in the art, for example, using a network. Herein, by way of example, host computers 22 and storage subsystem 20 are assumed to be coupled by a Storage Area Network (SAN) 26 incorporating data connections 24 and Host Bus Adapters (HBAs) 28. The logical addresses specify a range of data blocks within a logical volume, each block herein being assumed by way of example to contain 512 bytes. For example, a 10 KB data record used in a data processing application on a given host computer 22 would require 20 blocks, which the given host computer might specify as being stored at a logical address comprising blocks 1,000 through 1,019 of a logical volume. Storage subsystem 20 may operate in, or as, a SAN system.

Storage subsystem 20 comprises a clustered storage controller 34 coupled between SAN 26 and a private network 46 using data connections 30 and 44, respectively, and incorporating adapters 32 and 42, again respectively. In some configurations, adapters 32 and 42 may comprise host bus adapters (HBAs). Clustered storage controller 34 implements clusters of storage modules 36, each of which includes a storage processor 52, an interface 38 (in communication between adapters 32 and 42), and a cache 40. Each storage module 36 is responsible for a number of storage devices 50 by way of a data connection 48 as shown.

As described previously, each storage module 36 further comprises a given cache 40. However, it will be appreciated that the number of caches 40 used in storage subsystem 20 and in conjunction with clustered storage controller 34 may be any convenient number. While all caches 40 in storage subsystem 20 may operate in substantially the same manner and comprise substantially similar elements, this is not a requirement. Each of the caches 40 may be approximately equal in size and is assumed to be coupled, by way of example, in a one-to-one correspondence with a set of physical storage devices 50, which may comprise disks. In one embodiment, physical storage devices may comprise such disks. Those skilled in the art will be able to adapt the description herein to caches of different sizes.

Each set of storage devices 50 comprises multiple slow and/or fast access time mass storage devices, herein below assumed to be multiple hard disks. FIG. 1 shows caches 40 coupled to respective sets of storage devices 50. In some configurations, the sets of storage devices 50 comprise one or more hard disks, or solid state drives (SSDs) which can have different performance characteristics. In response to an I/O command, a given cache 40, by way of example, may read or write data at addressable physical locations of a given storage device 50. In the embodiment shown in FIG. 1, caches 40 are able to exercise certain control functions over storage devices 50. These control functions may alternatively be realized by hardware devices such as disk controllers (not shown), which are linked to caches 40.

Each storage module 36 is operative to monitor its state, including the states of associated caches 40, and to transmit configuration information to other components of storage subsystem 20 for example, configuration changes that result in blocking intervals, or limit the rate at which I/O requests for the sets of physical storage are accepted.

Routing of commands and data from HBAs 28 to clustered storage controller 34 and to each cache 40 may be performed over a network and/or a switch. Herein, by way of example, HBAs 28 may be coupled to storage modules 36 by at least one switch (not shown) of SAN 26, which can be of any known type having a digital cross-connect function. Additionally or alternatively, HBAs 28 may be coupled to storage modules 36.

In some embodiments, data having contiguous logical addresses can be distributed among storage modules 36, and within the storage devices in each of the modules. Alternatively, the data can be distributed using other algorithms, e.g., byte or block interleaving. In general, this increases bandwidth, for instance, by allowing a volume in a SAN or a file in network attached storage to be read from or written to more than one given storage device 50 at a time. However, this technique requires coordination among the various storage devices, and in practice may require complex provisions for any failure of the storage devices, and a strategy for dealing with error checking information, e.g., a technique for storing parity information relating to distributed data. Indeed, when logical unit partitions are distributed in sufficiently small granularity, data associated with a single logical unit may span all of the storage devices 50.

While such hardware is not explicitly shown for purposes of illustrative simplicity, clustered storage controller 34 may be adapted for implementation in conjunction with certain hardware, such as a rack mount system, a midplane, and/or a backplane. Indeed, private network 46 in one embodiment may be implemented using a backplane. Additional hardware such as the aforementioned switches, processors, controllers, memory devices, and the like may also be incorporated into clustered storage controller 34 and elsewhere within storage subsystem 20, again as the skilled artisan will appreciate. Further, a variety of software components, operating systems, firmware, and the like may be integrated into one storage subsystem 20.

Storage devices 50 may comprise a combination of high capacity hard disk drives and solid state disk drives. In some embodiments each of storage devices 50 may comprise a logical storage device. In storage systems implementing the Small Computer System Interface (SCSI) protocol, the logical storage devices may be referred to as logical units, or LUNs. While each LUN can be addressed as a single logical unit, the LUN may comprise a combination of high capacity hard disk drives and/or solid state disk drives.

While the configuration in FIG. 1 shows storage controller 34 having four storage modules 36 and each of the modules coupled to four storage devices 50, a given storage controller 34 comprising any multiple of storage modules 36 coupled to any plurality of storage devices 50 is considered to be with the spirit and scope of the present disclosure.

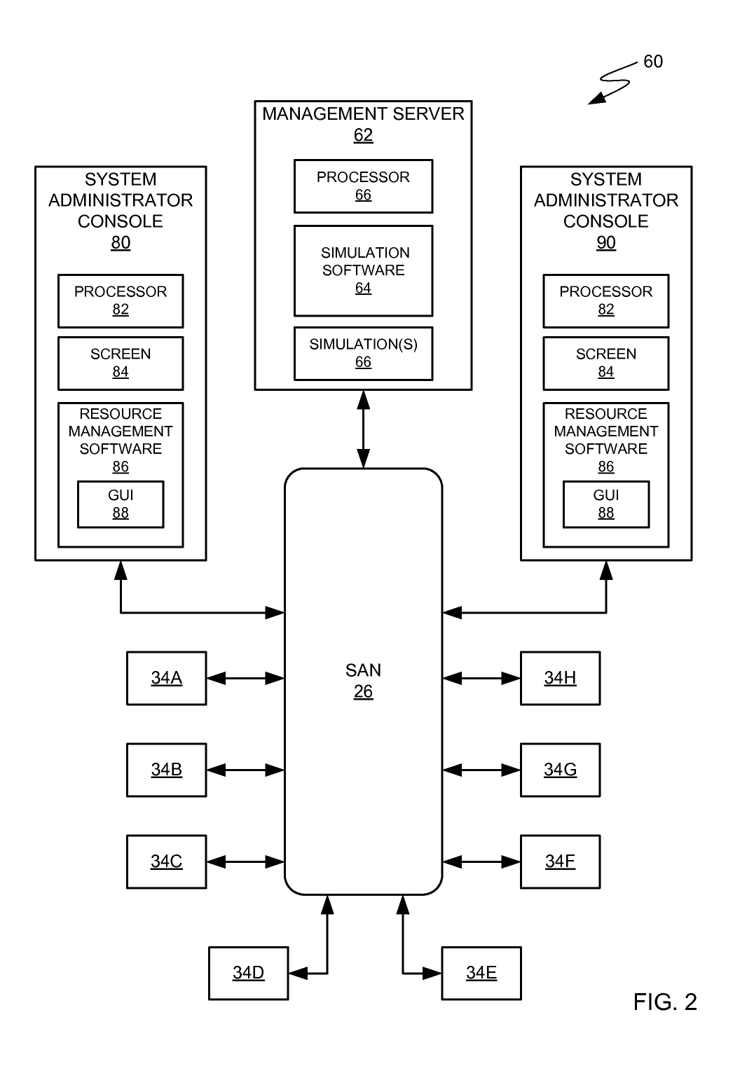

FIG. 2 is a block diagram that depicts a storage system that includes multiple storage controllers and multiple system administrator consoles, in accordance with an embodiment of the present disclosure. Specifically, FIG. 2 depicts an embodiment of storage system 60. Storage system 60 includes multiple examples of storage subsystem 20 and storage controller 34. The various examples of storage controllers 34 are differentiated by appending a letter to the identifying numeral, so that the storage controllers comprise storage controllers 34A-34H. Each of storage controllers 34A-34H manages a respective example of storage subsystem 20. In some embodiments, storage controllers 34A-34H and the respective storage subsystems are co-located at a single physical site and are communicatively connected over a network, such as SAN 26. In other embodiments, storage controllers 34A-34H and the respective storage subsystems are distributed across a plurality of physical sites and are communicatively connected over a network, such as the internet. In addition to storage controllers 34A-34H, storage system 60 includes a plurality of system administrator consoles (e.g., system administrator consoles 80 and 90) that are communicatively connected to a management server (e.g., management server 62). In various embodiments, system administrator consoles 80 and 90 and management server 62 can be standalone devices, severs, laptop computers, tablet computers, netbook computers, personal computers (PCs), desktop computers, or a mixture of the aforementioned computing devices. In another embodiment, one or more of system administrator consoles 80 and 90 and management server 62 represents a computing system utilizing clustered computers and components to act as a single pool of seamless resources. In general, each of system administrator consoles 80 and 90 can be any computing device or combination of devices with access to management server 62 and/or capable of executing resource management software 86. Similarly, management server 62 can be any computing device or combination of devices with access to system administrator consoles 80 and 90 and/or capable of executing simulation software 64.

In the embodiment depicted in FIG. 2, system administrator consoles 80 and 90 are communicatively connected to management server 62 over SAN 26. System administrator consoles 80 and 90 are also referred to as consoles 80 and 90 for descriptive simplicity. In other embodiments, consoled 80 and 90 are communicatively connected to management server 62 over another communication network such as a local area network (LAN), a wide area network (WAN) such as the internet, or a combination of networks. The communication network can include wired, wireless, fiber optic, or any other connection known in the art. In general, the communication network can be any network or combination of networks that will support communication between system administrator console 80 and 90 and management server 62.

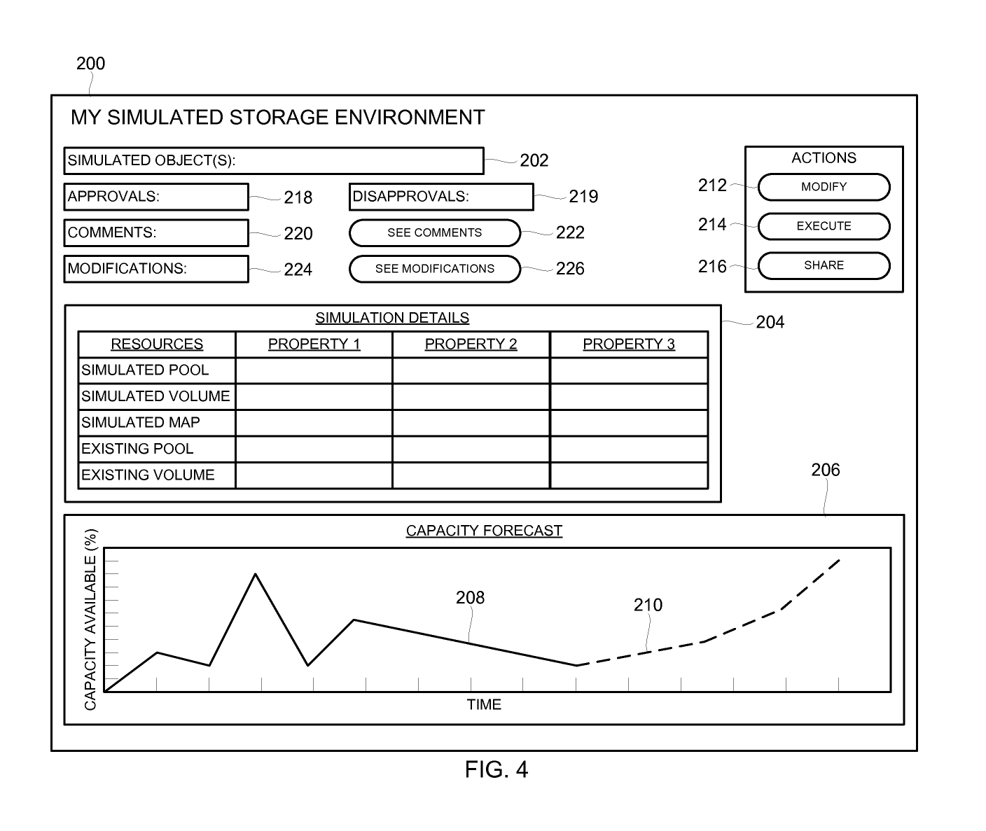

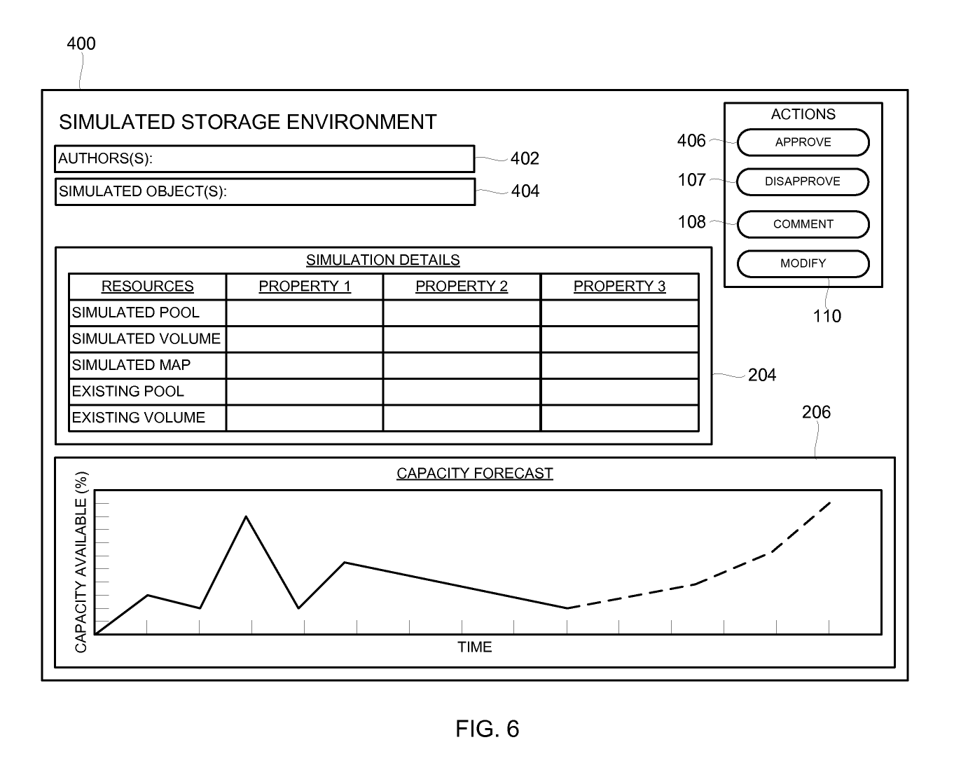

In the embodiment depicted in FIG. 2, system administrator consoles 80 and 90 each include processor 82 and screen 84. Processor 82 can be a general-purpose central processing unit(s) (CPUs) or special-purpose embedded processor(s), which are programmed in software or firmware to carry out the functions described herein. In operation, for example, processor 82 executes resource management software 86. Among other things, resource management software 86 provides graphical user interfere (GUI) 88. GUI 88 is presented on screen 84. GUI 88 includes the functionality discussed with respect to FIG. 4 and FIG. 6. In operation, GUI 88 presents the interface depicted in FIG. 4 or FIG. 6 based, at least in part, on whether a user of console 80/90 is simulating a resource management plan or a person who is reviewing a simulated plan that another person created.

In the embodiment depicted in FIG. 2, resource management software 86 is stored locally on a computer storage medium (e.g., random-access memory, a hard disk drive, a solid state drive, or another type of computer storage device) or it is provided locally on non-transitory tangible media (e.g., optical, magnetic or electronic memory media). In various other embodiments, resource management software 86 can reside on another computing device, provided that system administrator consoles 80 and 90 can access resource management software 86. In some embodiments, resource management software 86 is stored externally and is accessed through a communication network, such as one of the communication networks that can communicatively connect consoles 80 and 90 to management server 62.

In the embodiment depicted in FIG. 2, management server 62 is a standalone device and includes processor 66. Processor 66 includes general-purpose central processing unit(s) (CPUs) or special-purpose embedded processor(s), which are programmed in software or firmware to carry out the functions described herein. At least in part, management server 62 executes simulation software 64. In some embodiments, like the embodiment depicted in FIG. 2, simulation software 64 is stored locally on a computer storage medium (e.g., random-access memory, a hard disk drive, a solid state drive, or another type of computer storage device) or it is provided locally on non-transitory tangible media (e.g., optical, magnetic or electronic memory media). In other embodiments, simulation software 64 can reside on another computing device, provided that management server 62 can access simulation software 64. In yet other embodiments, simulation software 64 is stored externally and is accessed through a communication network, such as one of the communication networks that can communicatively connect consoles 80 and 90 to management server 62.

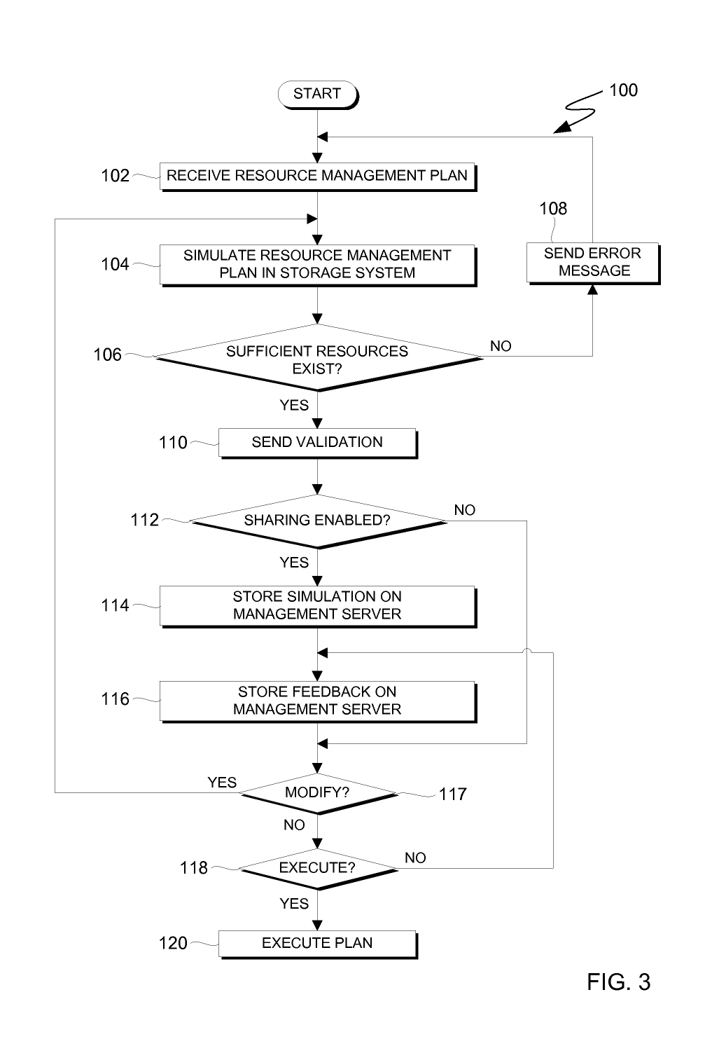

As described herein with respect to FIG. 3, management server 62 is able to accept one or more resource management plans from system administrator console 80, system administrator console 90, and/or another computing device that is communicatively connected to management server 62 and on which a resource management plan resides. Resource management plans are also referred to as “plans” or, where appropriate, “simulated plans” for descriptive simplicity. Management server 62 executes simulation software 64 to, at least in part, simulate the effects of resource management plans on one or more of storage controllers 34A-34H and the respective storage sub-systems. Management server 62 stores simulation(s) 66 based, at least in part, on the results of executing simulation software 64. In various embodiments, simulation(s) 66 are stored in one of the ways in which simulation software 64 can be stored. Simulation(s) 66 can include (i) one or more simulated (i.e., virtual) objects that are created as a result of simulating a plan, (ii) information relating to existing objects that are changed by a simulated plan, and/or (iii) information relating to existing objects that deleted by a simulated plan. As described herein with respect to FIGS. 4 and 6, simulation(s) 66 can also include various forms of feedback (e.g., as meta-data). A user of system administrator console 80 (i.e., a first system administrator), a user of system administrator console 90 (i.e., a second system administrator), and other system administrators or persons with access to management server 62 can access simulation(s) 66 to view, comment on, and/or modify simulation(s) 66, as described herein.

FIG. 3 is a flowchart depicting operations for simulating the effects of resource management plans on a computing device within the computing environment of FIG. 2, in accordance with an embodiment of the present disclosure. For example, FIG. 2 is a flowchart depicting operations 100 of simulation software 64 as executed on processor 66 of management server 62. In other embodiments, however, processor 82 of system administrator console 80/90 executes simulation software 64 and system administrator console 80/90 includes hardware and software to provide the functionality described with respect to management server 62.

In operation 102, management server 62 receives from system administrator console 80, for example, a resource management plan that was created by the first system administrator (i.e., a user of console 80). Simulation software 64 generates simulation(s) 66 based, at least in part, on the resource management plan (operation 104). Simulation(s) 66 include information that describes how the resource management plan affects the resources of storage system 60. In various embodiments, the resource management plan creates simulated (i.e., virtual) object(s), deletes existing object(s), modifies existing object(s), and/or modifies one or more of resources of storage system 60 in another way. For example, resource management plans can include, but are not limited to, moving a specific storage object from a first location to a second location (e.g., moving a storage pool from a first storage controller to a second storage controller, or moving a logical volume from a first storage pool to a second storage pool), creating an additional storage object (e.g., creating an additional storage pool in a given storage controller), and resizing a specific storage object from a first size to a second size.

In the embodiment depicted in FIG. 3, one function of simulation(s) 66 is to determine if storage system 60 includes sufficient resources to implement the plan (decision 106). If storage system 60 does not include sufficient resources to implement the plan (decision 106, NO branch), management server 62 sends an error message to, in this example, console 80 (108). If sufficient resources to implement the plan exist (decision 106, YES branch), management server 62 sends a validation to console 80 (110). In the embodiment depicted in FIG. 2, the first system administrator is able to view the error message sent in operation 108 or the validation sent in operation 110 on screen 84 of console 80 via resource management software 86 and GUI 88. In addition, some embodiments of simulation software 64 include trend analysis mechanisms to forecast how the plan will affect the resources of storage system 60 in the future, as discussed with respect in FIGS. 4 and 6.

One advantage of simulation software 64 is that simulation(s) 66 are stored on management server 62 so that a first person (e.g., the first system administrator), may allow other person(s) (e.g., the second system administrator) to review the simulated plan. In some embodiments, however, simulation(s) 66 can be accessed on management server 62 by any authorized person. In other embodiments, simulation software 64 permits authorized persons to access one or more of simulation(s) 66 after determining that a person who has control over the simulated plan (e.g., the author of the plan or another person) has allowed the simulation to be shared. In the embodiment depicted in FIG. 3, simulation software 64 shares the simulation of the resource management plan with other persons after determining that the first system administrator has enabled sharing of the simulation (decision 112). In some embodiments, sharing the simulation includes granting access to the simulation on management server 62 to one or more persons. In other embodiments, sharing the simulation includes sending the simulation to one or more persons. In various embodiments, sharing the simulation also include notifying one or more persons that the simulation can be viewed on management server 62. If the first system administrator has not enabled sharing (decision 112, NO branch), simulation software 64 determines whether or not modifications to the plan exist (decision 117). If the first system administrator has enabled sharing (decision 112, YES branch), simulation software 64 stores the simulation on management server 62 (114). In some embodiments, operation 114 includes transferring the simulation from system memory to a non-volatile storage medium (e.g., one or more hard disk drives and/or solid state drives). In other embodiments, operation 114 includes retaining the simulation of the plan in a non-volatile storage medium. If system administrators or other authorized persons provide feedback on the plan (e.g., by approving, commenting on, or modifying the plan), simulation software 64 causes management server 62 to store the feedback (116)

If the plan is modified prior to execution of the plan (decision 117, YES branch), the modified plan is simulated. Modifications to the plan can be based, at least in part, on feedback stored in operation 116, the volition of the first system administrator (i.e., the author of the plan), or another factor. If the plan has not been modified (decision 117, NO branch), simulation software 64 performs decision 118. Simulation software 64 performs operation 116 and decision 117 until management server 62 receives valid instructions to execute the plan or delete the plan (decision 118, NO branch). In some embodiments, the author of the simulated plan or another person having control over the simulated plan can provide valid instructions to execute the plan. In response to receiving valid instructions to execute the simulated plan (decision 118, YES branch), simulation software 64 causes management server 62 to execute the resource management plan on storage system 60.

FIG. 4 is a block diagram of a graphical user interface for sharing a simulated resource management plan, in accordance with an embodiment of the present disclosure. Specifically, FIG. 4 depicts, at least in part, GUI 88 as presented on screen 84 of system administrator console 80, where the first system administrator is a user of console 80 who has authored a plan that is simulated by management server 62.

In the embodiment depicted in FIG. 4, window 200 is a summary of a simulated resource management plan. Window 200 includes simulated object field 202 that lists the simulated objects (i.e., new or modified objects), simulation details table 204, forecast 206, a menu that includes buttons for performing various actions, and various forms of feedback.

Simulation details table 204 and forecast 206 describe, at least in part, how various aspects of storage system 60 are affected by a simulated resource management plan. In FIG. 4, simulation details table 204 provides information concerning a plurality of properties as they relate to a simulated pool, a simulated volume, and a simulated map. For example, simulation details table 204 can described whether or not data in a particular resource is mirrored, how such data is mirrored, a utilization percentage of a particular resource, how much capacity is available on a particular resource, and/or information relating to another property of storage system 60. Persons of ordinary skill in the art will understand that the specific architecture of storage system 60 will determine the properties that simulation details table 204 can advantageously display. Simulation details table 204 also provides these details with respect to the simulated pool and the simulated volume as they exist on storage system 60 prior to the simulated plan taking affect (i.e., the existing pool and the existing volume). A person having control over the simulated plan (i.e., the first system administrator) can therefore see the effects of the plan on storage system 60.

In addition, forecast 206 graphically shows how the simulated plan affects various aspects of storage system 60. In the embodiment depicted in FIG. 4, forecast 206 depicts how the capacity of storage system 60 (or a component of storage system 60, such as a specific pool or volume) is affected by the simulated plan in terms of available capacity. Forecast 206 includes historical portion 208 and projected portion 210 to distinguish the historical trend from the predicted/simulated trend. In various embodiments, the historical portion 208 and the projected portion 210 are differentiated based on line pattern, line color, stroke width, or another visual attribute.

In the embodiment depicted in FIG. 4, window 200 also include a plurality of buttons for taking various action with respect to the simulated plan. Button 212 enables the first system administrator (i.e., a user of system administrator console 80) to modify various aspects of the simulated plan based, at least in part, on information simulation details table 204, forecast 206, feedback from other system administrators, and/or another reason. If the first system administrator does not wish to modify the simulated plan, he or she can execute the plan using button 214 or share the plan using button 216. In some embodiments, sharing the simulated plan via button 216 makes the simulated plan available to any person with access to simulation(s) 66 on management server 62. In other embodiments, sharing the simulated plan via button 216 activates a dialogue and/or text box that enables the first system administrator to share the simulated plan with specific individuals (e.g., the second system administrator). In yet other embodiments, activating button 216 activates a dialogue and/or text box that enables the first system administrator to select from the aforementioned and/or other options for sharing the simulated plan.

As described herein with respect to FIG. 6, another aspect of resource management software 86 and GUI 88 is to enable system administrators to provide feedback concerning the simulated plans of other system administrators. Window 200 summarizes at least some of this feedback. For example, the embodiment depicted in FIG. 6 includes approval field 218 and disapproval field 219 that respectively reflect a count of persons who have approved of and disapproved of the simulated plan. Window 200 also includes comment field 220 and modification field 224. Comment field 220 and modification field 224 respectively reflect a count comments and a count of modifications concerning the simulated plan. Based, at least in part, on comment field 220 and modification field 224, the first system administrator can activate comment button 222 and modification button 226 to respectively view the details of the comment(s) and/or modification(s).

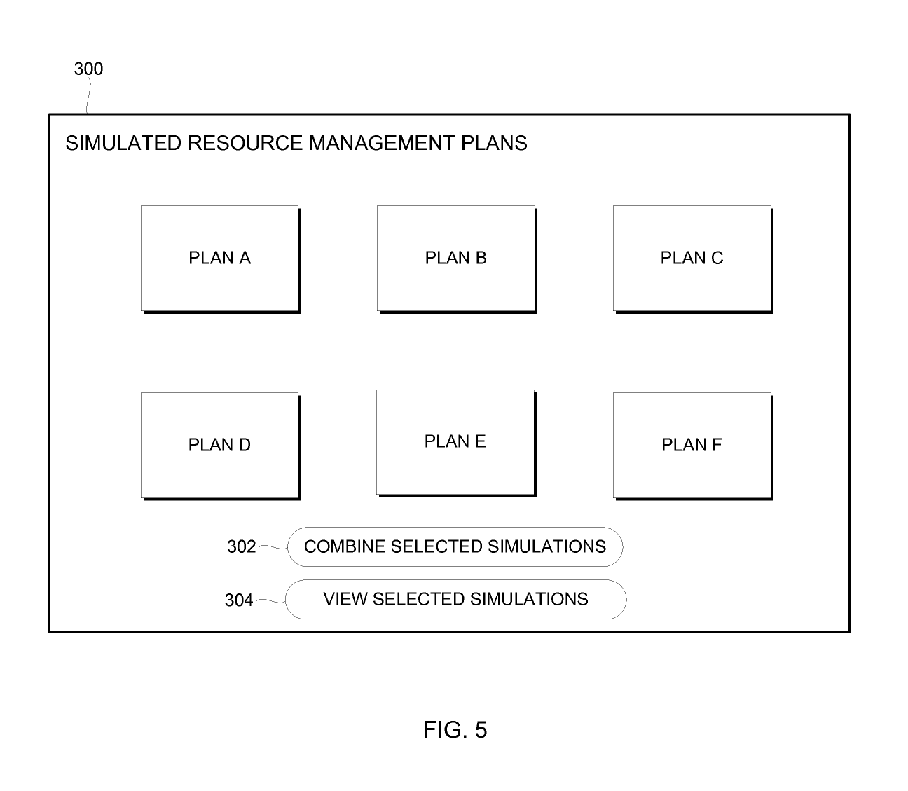

FIG. 5 is a block diagram of a graphical user interface for selecting a simulated resource management plan, in accordance with an embodiment of the present disclosure. Specifically, FIG. 5 is an example of one aspect of GUI 88 and resource management software 86 as executed on system administrator console 90, where the user of console 90 (i.e., the second system administrator) is selecting from among simulation(s) 66 on management server 62.

In the embodiment depicted in FIG. 5, window 300 includes a plurality of objects that represent simulations of various resource management plans. Each simulation is associated with a unique ID to, at least in part, differentiate the simulations from one another. In some embodiments, the second system administrator can select one simulation and activate button 304 to view and/or provide feedback concerning various aspects of the simulation, as described with respect to FIG. 6. In the embodiment depicted in FIG. 5, however, the second system administrator can select one or more simulations in window 300. If the second system administrator selects more than one simulations, he or she can and activate button 302 to view the effects of the combination of simulations on storage system 60 or activate button 304 to view the effects of the selected simulations on storage system 60 individually. If, for example, Plan A and Plan B in window 300 utilize some of the same resources on storage system 60, the second system administrator may wish to view the effects of the combination of Plan A and Plan B on storage system 60. In some cases, combining two or more simulations causes simulation software 64 to automatically combine the respective resource management plans (e.g., Plans A and B), simulate the combination of plans, and store the resulting simulation on management server 62 such that the simulation appears in window 300 (e.g., as one of Plan C, D, E, or F). In other cases, two or more simulations can be combined without requiring simulation software 64 to simulate a combination of the associated resource management plans.

FIG. 6 is a block diagram of a graphical user interface for reviewing a simulated resource management plan, in accordance with an embodiment of the present disclosure. Specifically, FIG. 6 is an example of one aspect of GUI 88 and resource management software 86 as executed on system administrator console 90, where the user of console 90 (i.e., the second system administrator) is viewing a simulation selected from among simulation(s) 66 on management server 62.

In the embodiment depicted in FIG. 4, window 400 identifies the author(s) of the simulation(s) in field 402 and any simulated object(s) in field 404. Window 400 also includes simulation details table 204 and forecast 206, as described with respect to FIG. 4. In addition, window 400 includes a plurality of buttons than allow the second system administrator to provide feedback regarding the selected simulation(s). For example, the second system administrator can activate approval button 406 to indicate approval of the simulated resource management plan or activate disapproval button 407 to indicate disapproval of the simulated plan. As discussed with respect to FIG. 4, activating approval button 406 will increase the count of approvals reflected in approval field 218 of window 200 to increase by one. Similarly, activating disapproval button 407 will increase the count of disapprovals reflected in disapproval field 219 of window 200 to increase by one. If the second system administrator wishes to provide more substantive feedback on the simulated plan, he or she can activate comment button 408. In some embodiments, activating comment button 408 activates a text box into which the second system administrator can input comments. In other embodiments, activating comment button 408 provides a window having a text box into which the second system administrator can input comments. Similarly, the second system administrator can activate modification button 410 if he or she wishes to modify the simulated plan. Activating modification button 410 provides a window having a dialogue and/or text box that enable the second system administrator to make various changes to the simulated plan.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

As used herein, a list of alternatives such as “at least one of A, B, and C” should be interpreted to mean “at least one A, at least one B, at least one C, or any combination of A, B, and C.”

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
simulating, by one or more computer processors, one or more effects of a resource management plan on a data storage system by generating a simulation based, at least in part, on the data storage system and the resource management plan;
granting, by one or more computer processors, access to the simulation to at least one person who is not an author of the resource management plan;
receiving, by one or more computer processors, feedback of one or more types from the at least one person; and
modifying, by one or more computer processors, the data storage system based, at least in part, on the resource management plan and the feedback of one or more types from the at least one person.

2. The method of claim 1, further comprising:
generating, by one or more computer processors, an error message for the author of the resource management plan in response to determining, by one or more computer processors, that the data storage system does not have sufficient resources to execute the resource management plan.

3. The method of claim 1, further comprising:
generating, by one or more computer processors, a validation for the author of the resource management plan in response to determining, by one or more computer processors, that the data storage system has sufficient resources to execute the resource management plan.

4. The method of claim 1, further comprising:
receiving, by one or more computer processors, one or more modifications to the resource management plan and, in response, modifying, by one or more computer processors, the simulation based, at least in part, on the one or more modifications received.

5. The method of claim 1, further comprising:
forecasting, by one or more computer processors, a change to a property of the data storage system based, at least in part, on executing the resource management plan on the data storage system, wherein the change is forecasted by:
determining, by one or more computer processors, a historical trend reflecting changes to the property prior to executing the resource management plan; and
determining, by one or more computer processors, a projected trend reflecting predicted changes to the property based, and least in part, on executing the resource management plan.

6. The method of claim 1, wherein the at least one person granted access to the simulation is at least one person having access to a management server on which the simulation and the feedback are stored.

7. The method of claim 1, wherein the at least one person granted access to the simulation is one or more named persons, wherein only the author of the resource management plan and the one or more named persons have access to the simulation.

8. The method of claim 1, wherein the feedback of one or more types includes feedback of types including at least one of a count of approvals, a count of disapprovals, comments concerning the resource management plan, and suggested modifications to the resource management plan.

9. A computer program product comprising:
a computer readable storage medium and program instructions stored on the computer readable storage medium, the program instructions comprising:
program instructions to simulate one or more effects of a resource management plan on a data storage system by generating a simulation based, at least in part, on the data storage system and the resource management plan;
program instructions to grant access to the simulation to at least one person who is not an author of the resource management plan;
program instructions to receive feedback of one or more types from the at least one person; and
program instructions to modify the data storage system based, at least in part, on the resource management plan and the feedback of one or more types from the at least one person.

10. The computer program product of claim 9, the program instructions further comprising:
program instructions to determine that the data storage system does not have sufficient resources to execute the resource management plan, and in response, generate an error message for the author of the resource management plan; and
program instructions to determine that the data storage system has sufficient resources to execute the resource management plan, and in response, generate a validation for the author of the resource management plan.

11. The computer program product of claim 9, the program instructions further comprising:
program instructions to receive one or more modifications to the resource management plan, and in response, modify the simulation based, at least in part, on the one or more modifications received.

12. The computer program product of claim 9, the program instructions further comprising:
program instructions to forecast a change to a property of the data storage system based, at least in part, on the one or more effects of the resource management plan on the data storage system, wherein the program instructions to forecast the change include:
program instructions to determine a historical trend reflecting changes to the property prior to executing the resource management plan; and
program instructions to determine a projected trend reflecting predicted changes to the property based, and least in part, on the one or more effects of the resource management plan.

13. The computer program product of claim 9, wherein the at least one person granted access to the simulation is at least one person having access to a management server on which the simulation and the feedback are stored.

14. The computer program product of claim 9, wherein the feedback of one or more types includes feedback of types including at least one of a count of approvals, a count of disapprovals, comments concerning the resource management plan, and suggested modifications to the resource management plan.

15. A computer system comprising:
one or more computer processors;
one or more computer readable storage media;
program instructions stored on the computer readable storage media for execution by at least one of the one or more processors, the program instructions comprising:
program instructions to simulate one or more effects of a resource management plan on a data storage system by generating a simulation based, at least in part, on the data storage system and the resource management plan;
program instructions to grant access to the simulation to at least one person who is not an author of the resource management plan;
program instructions to receive feedback of one or more types from the at least one person; and
program instructions to modify the data storage system based, at least in part, on the resource management plan and the feedback of one or more types from the at least one person.

16. The computer system of claim 15, the program instructions further comprising:
program instructions to determine that the data storage system does not have sufficient resources to execute the resource management plan, and in response, generate an error message for the author of the resource management plan; and
program instructions to determine that the data storage system has sufficient resources to execute the resource management plan, and in response, generate a validation for the author of the resource management plan.

17. The computer system of claim 15, the program instructions further comprising:
program instructions to receive one or more modifications to the resource management plan, and in response, modify the simulation based, at least in part, on the one or more modifications received.

18. The computer system of claim 15, the program instructions further comprising:
program instructions to forecast a change to a property of the data storage system based, at least in part, on the one or more effects of the resource management plan on the data storage system, wherein the program instructions to forecast the change include:
program instructions to determine a historical trend reflecting changes to the property prior to executing the resource management plan; and
program instructions to determine a projected trend reflecting predicted changes to the property based, and least in part, on the one or more effects of the resource management plan.

19. The computer system of claim 15, wherein the at least one person granted access to the simulation is at least one person having access to a management server on which the simulation and the feedback are stored.

20. The computer system of claim 15, wherein the feedback of one or more types includes feedback of types including at least one of a count of approvals, a count of disapprovals, comments concerning the resource management plan, and suggested modifications to the resource management plan.
